(19) United States
(12) Patent Application Publication
(10) Pub. No.: US 2013/0158957 A1
(43) Pub. Date: Jun. 20, 2013

(54) LIBRARY GENERATION WITH DERIVATIVES IN OPTICAL METROLOGY

(71) Applicants: Lie-Quan Lee, Fremont, CA (US); Leonid Poslavsky, Belmont, CA (US)

(72) Inventors: Lie-Quan Lee, Fremont, CA (US); Leonid Poslavsky, Belmont, CA (US)

(21) Appl. No.: 13/610,613

(22) Filed: Sep. 11, 2012

Related U.S. Application Data
(60) Provisional application No. 61/576,817, filed on Dec. 16, 2011.

(51) Int. Cl. G06F 17/40; G06F 17/50

(52) U.S. Cl. 703/1; 702/187

(57) ABSTRACT

Methods of library generation with derivatives for optical metrology are described. For example, a method of generating a library for optical metrology includes determining a function of a parameter data set for one or more repeating structures on a semiconductor substrate or wafer. The method also includes determining a first derivative of the function of the parameter data set. The method also includes providing a spectral library based on both the function and the first derivative of the function.

### CROSS-REFERENCE TO RELATED APPLICATIONS

This application claims the benefit of U.S. Provisional Application No. 61/576,817, filed Dec. 16, 2011, the entire contents of which are hereby incorporated by reference herein.

### TECHNICAL FIELD

Embodiments of the present invention are in the field of metrology, and, more particularly, relate to methods of library generation with derivatives for optical metrology.

### BACKGROUND

For the past several years, a rigorous couple wave approach (RCWA) and similar algorithms have been widely used for the study and design of diffraction structures. In the RCWA approach, the profiles of periodic structures are approximated by a given number of sufficiently thin planar grating slabs. Specifically, RCWA involves three main operations, namely, the Fourier expansion of the field inside the grating, calculation of the eigenvalues and eigenvectors of a constant coefficient matrix that characterizes the diffracted signal, and solution of a linear system deduced from the boundary matching conditions. RCWA divides the problem into three distinct spatial regions: (1) the ambient region supporting the incident plane wave field and a summation over all reflected diffracted orders, (2) the grating structure and underlying non-patterned layers in which the wave field is treated as a superposition of modes associated with each diffracted order, and (3) the substrate containing the transmitted wave field.

The accuracy of the RCWA solution depends, in part, on the number of terms retained in the space-harmonic expansion of the wave fields, with conservation of energy being satisfied in general. The number of terms retained is a function of the number of diffraction orders considered during the calculations. Efficient generation of a simulated diffraction signal for a given hypothetical profile involves selection of the optimal set of diffraction orders at each wavelength for both transverse-magnetic (TM) and/or transverse-electric (TE) components of the diffraction signal. Mathematically, the more diffraction orders selected, the more accurate the simulations. However, the higher the number of diffraction orders, the more computation is required for calculating the simulated diffraction signal. Moreover, the computation time is a nonlinear function of the number of orders used.

The input to the RCWA calculation is a profile or model of the periodic structure. In some cases cross-sectional electron micrographs are available (from, for example, a scanning electron microscope or a transmission electron microscope). When available, such images can be used to guide the construction of the model. However a wafer cannot be cross sectioned until all desired processing operations have been completed, which may take many days or weeks, depending on the number of subsequent processing operations. Even after all the desired processing operations are complete, the process to generate cross sectional images can take many hours to a few days because of the many operations involved in sample preparation and in finding the right location to image. Furthermore the cross section process is expensive because of the time, skilled labor and sophisticated equipment needed, and it destroys the wafer.

Thus, there is a need for a method for efficiently generating an accurate model of a periodic structure given limited information about that structure, a method for optimizing the parameterization of that structure and a method of optimizing the measurement of that structure.

### SUMMARY

Embodiments of the present invention include methods of library generation with derivatives for optical metrology.

In an embodiment, a method of generating a library for optical metrology includes determining a function of a parameter data set for one or more repeating structures on a semiconductor substrate or wafer. The method also includes determining a first derivative of the function of the parameter data set. The method also includes providing a spectral library based on both the function and the first derivative of the function.

In another embodiment, a non-transitory machine-accessible storage medium has instructions stored thereon which cause a data processing system to perform a method of generating a library for optical metrology. The method includes determining a function of a parameter data set for one or more repeating structures on a semiconductor substrate or wafer. The method also includes determining a first derivative of the function of the parameter data set. The method also includes providing a spectral library based on both the function and the first derivative of the function.

In another embodiment, a system to generate a simulated diffraction signal to determine process parameters of a wafer application to fabricate a structure on a wafer using optical metrology includes a fabrication cluster configured to perform a wafer application to fabricate a structure on a wafer. One or more process parameters characterize behavior of structure shape or layer thickness when the structure undergoes processing operations in the wafer application performed using the fabrication cluster. The system also includes an optical metrology system configured to determine the one or more process parameters of the wafer application. The optical metrology system includes a beam source and detector configured to measure a diffraction signal of the structure. The optical metrology system also includes a spectral library of simulated diffraction signals. The spectral library based on both a function and a first derivative of the function of a parameter data set of a plurality of model structures. The optical metrology system also includes a processor configured to determine, from the plurality of model structures, a model of the structure.

### BRIEF DESCRIPTION OF THE DRAWINGS

FIG. 1 is an illustration of a two-hidden layers neural network useful for modeling in optical metrology, in accordance with an embodiment of the present invention.

FIG. 2 is a Table illustrating three test cases for implementing derivatives information, in accordance with an embodiment of the present invention.

FIG. 3 is a Table summarizing the standard deviation of errors for the three test cases of the Table of FIG. 2, in accordance with an embodiment of the present invention.

FIG. 4 illustrates a screen shot of a testing workbook, in accordance with an embodiment of the present invention.

FIG. 5 includes plots of the Error3Sigma divided by precision for 50 testing profiles in three different regions based on the workbook of FIG. 4, in accordance with an embodiment of the present invention.

FIG. 6 illustrates a profile geometry of a more complicated workbook, in accordance with an embodiment of the present invention.

FIG. 7 includes a plot of the Error3Sigma divided by precision in three different regions based on the workbook of FIG. 6 without using derivative information.

FIG. 8 includes plots of the Error3Sigma divided by precision in three different regions based on the workbook of FIG. 6 using derivative information, each plot utilizing a different number of profiles, in accordance with an embodiment of the present invention.

FIG. 9 includes a plot revealing a speedup factor for computations for a workbook using 10 degrees of freedom (DOFs) along with derivative information, in accordance with an embodiment of the present invention.

FIG. 10 includes a plot demonstrating a speedup prediction for varying DOFs based on a fixed computational cost of a derivative of 20%, in accordance with an embodiment of the present invention.

FIG. 11 depicts a flowchart representing operations in a method of library generation with derivatives for optical metrology, in accordance with an embodiment of the present invention.

FIG. 12 depicts a flowchart representing an exemplary series of operations for determining and utilizing structural parameters for automated process and equipment control, in accordance with an embodiment of the present invention.

FIG. 13 is an exemplary block diagram of a system for determining and utilizing structural parameters for automated process and equipment control, in accordance with an embodiment of the present invention.

FIG. 14A depicts a periodic grating having a profile that varies in the x-y plane, in accordance with an embodiment of the present invention.

FIG. 14B depicts a periodic grating having a profile that varies in the x-direction but not in the y-direction, in accordance with an embodiment of the present invention.

FIG. 15 represents a cross-sectional view of a structure having both a two-dimensional component and a three-dimensional component, in accordance with an embodiment of the present invention.

FIG. 16 is a first architectural diagram illustrating the utilization of optical metrology to determine parameters of structures on a semiconductor wafer, in accordance with embodiments of the present invention.

FIG. 17 is a second architectural diagram illustrating the utilization of optical metrology to determine parameters of structures on a semiconductor wafer, in accordance with embodiments of the present invention.

FIG. 18 illustrates a block diagram of an exemplary computer system, in accordance with an embodiment of the present invention.

FIG. 19 is a flowchart representing operations in a method for a building parameterized model and a spectral library beginning with sample spectra, in accordance with an embodiment of the present invention.

FIG. 20 is an illustrative flowchart representing operations in a method for building a library for making production measurements of a structure, in accordance with an embodiment of this invention.

### DETAILED DESCRIPTION

Methods of library generation with derivatives for optical metrology are described herein. In the following description, numerous specific details are set forth, such as specific approaches to obtaining and performing computations using derivatives, in order to provide a thorough understanding of embodiments of the present invention. It will be apparent to one skilled in the art that embodiments of the present invention may be practiced without these specific details. In other instances, well-known processing operations, such as fabricating stacks of patterned material layers, are not described in detail in order to not unnecessarily obscure embodiments of the present invention. Furthermore, it is to be understood that the various embodiments shown in the figures are illustrative representations and are not necessarily drawn to scale.

Embodiments of the present invention may be directed toward improving a model, such as an optical model. The improvement or optimization may be achieved by reducing a modeled space and library size, choosing a best parameterization, or reducing the model degrees of freedom (DOF). The benefits may be realized with minimal cost, such as computation cost, and a reduced time for regression. One or more embodiments may include analysis and library generation, improving library training, improving an analysis sensitivity and correlation results, reducing library toggling effect and improving a library-to-regression matching. In one particular embodiment, the model parameters are constrained only within the process variation space, reducing the overall time to results.

More specifically, one or more embodiments described herein are directed to approaches for generating libraries utilizing derivatives. The derivatives mused may be analytical derivatives (which may be computationally fast) or numerical derivatives (which may be computationally slow), or a combination of both. For analytical derivatives, computations may be expedited since, as a very basic example, if a function to be analyzed is depends on X², then only a function depending on 2× need be considered to obtain first derivative information. For numerical derivatives, computations may be somewhat hampered since for a given function, a variety of computations based on [(function+delta)−(function)]/delta must be considered since a finite difference is used for the computation. However, for years it was thought that analytical derivatives did not exist for optical metrology purposes. Additionally, although analytical derivatives may require less time to compute, it was thought difficult to implement such information in optical metrology. Furthermore, there may be significant overhead with actually implementing analytical derivatives. But, once obtained, computations using such analytical derivatives may be streamlined. As such, in accordance with one or more embodiments, computations for modeling in optical metrology include information based on function plus derivative versus function only. In one such embodiment, approaches described herein provide much improved accuracy for modeling in optical metrology.

Benefits of using approaches described herein may include, but are not limited to, an ability to obtain more useful information based on more accurate modeling. One or more approaches may enable a reduction in sheer number of points needed in a spectral library, e.g., reduction by an order of magnitude, since it may not be necessary to evaluate as many functions if no derivatives are used. Accordingly, each computation is effectively “smarter” overall since more information is included with the derivative component of the function. Another benefit may include an improvement in library quality. Since a derivative is literally a trend of the analyzed function, computation is improved since trending factors are addressed. Additionally, in some embodiments, a further reduction in sheer number of data points needed is reduced by using, in addition to first derivative information, higher order derivatives, e.g., derivatives higher order than the first derivative.

In order to illustrate concepts described herein, an introduction to library approaches for optical metrology is provided below. In such approaches, given a system that follows physical laws (e.g., Maxwell's equations), one set of input values (e.g., unknowns) is used to determine an output (e.g., results). A computer model may be used to perform the calculations in order to obtain the results. The above is known as a forward problem. In optical metrology such as ellipsometry, reflectometry, scatterometry, etc., the output may be measured and it needs to be determined what the corresponding input values are. This is known as an inverse problem. The inverse problem may be defined as follows: find the values of the bounded parameter set p by minimizing the following quadratic form, or the weighted mean square error provided in equation (1):

$${χ}^{2} = \frac{1}{2} ( \frac{{( ( p ) - )}^{2}}{{σ}_{a}^{1}} + \frac{{( ( p ) - )}^{2}}{{σ}_{β}^{1}} ) , \qquad ( 1 )$$

where \tilde{α}_{A} and \tilde{β}_{A} are the representative measurement spectra, α_{A}(p) and β_{A}(p) are the calculated spectra. Parameters p can include geometric parameters such as, but not limited to, CD, height, angle, film thickness, dielectric constants, system parameters such as wavelength, angle of incidence, calibration parameters, etc. There are optimization algorithms available to solve the above minimization problem. In such algorithms, one of the essential operations is to evaluate α_{A}(p) and β_{A}(p) given a specific p. Namely, the forward problem must be solved. However, it may be very time-consuming to solve the forward problem and the performance of the optimization is dominated by that hurdle. In order to effectively “speed-up” the optimization procedure, a meta-model (or reduced order model) of the original forward problem may be built. Such a meta-model is typically referred to as a library.

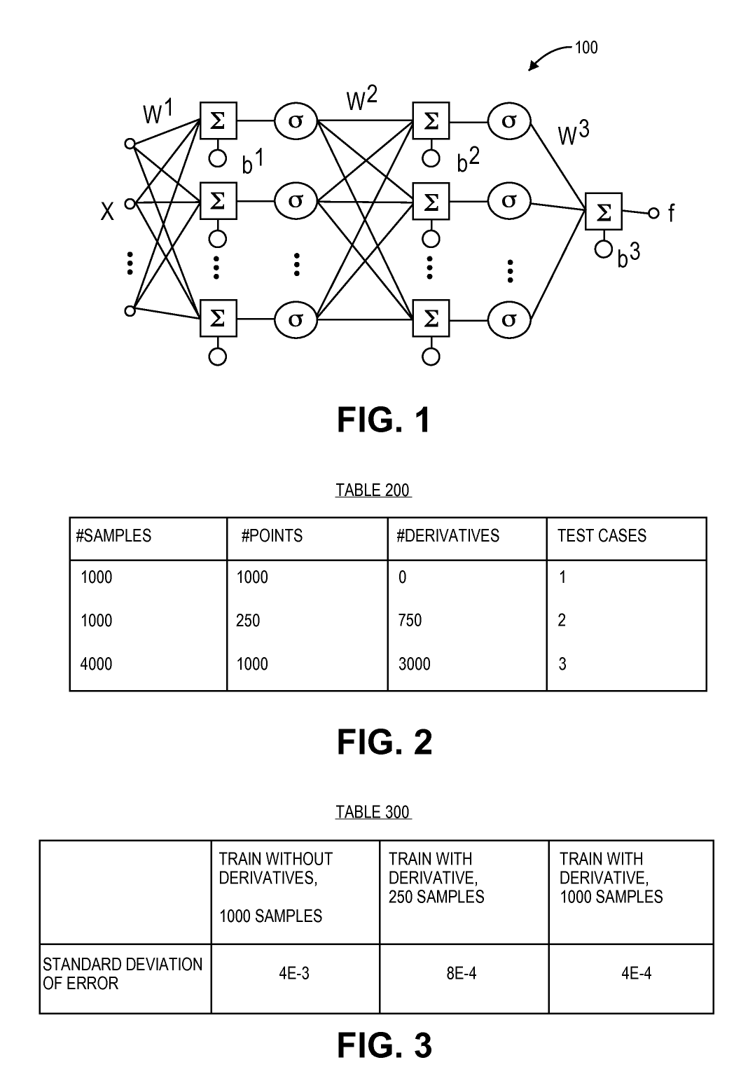

In one such example, a neural network such as a feed-forward neural network may be used to implement a nonlinear mapping function F so that y≈F(p). Such a function may be used as the library in order to very quickly determine corresponding spectra based on a given a profile. The function may be determined in a so-called training procedure with a set of training data (pᵢ, yᵢ). As a specific example, FIG. 1 is an illustration of a two-hidden layers neural network useful for modeling in optical metrology, in accordance with an embodiment of the present invention. Theoretically, it is guaranteed that such a network can approximate any arbitrary nonlinear function. Referring to FIG. 1, a mapping 100 is used to provide a mapping function from input x to output f and is approximated with the two-hidden layer neural network 100 in a mathematical way. Given a set of training data, the training may be viewed as solving an optimization problem for minimizing a mean squared error. Specifically, given a parameter set x, the function values represented by the neural network 100 is provided in equation (2):

f=W³σ₂(W²σ₁(W¹x+b¹)+b²)+b³ (2).

For library generation, accurate neural network models may be constructed such that the neural networks can be used to accurately calculate spectra given a particular profile, such as a structural profile. In machine learning language, this is referred to a neural network training. Training algorithms, however, pose an optimization problem in their own right. For example, denoting a profile x as a set of parameters defined above, and given a set of profiles {xᵢ} and their corresponding spectra {yᵢ}, the training algorithm is used to minimize the objective function for a given neural network architecture as shown in equation (3):

$${Min}_{{W}^{1} , {W}^{2} , {W}^{3} , {b}^{3} , {b}^{2} , {b}^{1}} ( \frac{1}{N} {\sum }_{i = 1}^{N} {( f ( {x}_{i} ) - {y}_{i} )}^{2} ) . \qquad ( 3 )$$

Typically, a large number of data sets is required in order for training algorithms to find a set of neural network coefficients that can accurately represent the original forward problem. Each data point {xᵢ, yᵢ} requires solving Maxwell equations, which may be very time-consuming.

In accordance with one or more embodiments of the present invention, analytical derivatives of spectra are evaluated with respect to a given parameter set with reduced computational cost versus a full forward solve approach. In an embodiment, a method for library generation includes using, in addition to a set of profiles and their corresponding spectra, the derivatives of spectra with respect to a parameter set for training neural networks.

To further illustrate one or more concepts described herein, if an amount of information used in the above training were normalized, and given a model with a given number of degrees of freedom (NDOF), the amount of information for N profiles, the corresponding spectra, and derivatives are equivalent to N*(NDOF+1). This outcome indicates the possibility of significantly reducing the number of profiles in generating a library with similar accuracy. Therefore, in an embodiment, overall library generation time is significantly reduced. That is, if N profiles are required to generate a library without using derivatives, only N/(NDOF+1) profiles are needed when derivative information is included in the training. Furthermore, in an embodiment, training with derivatives improves the derivatives calculated from neural networks. Thus, possible library quality improvement may be achieved through library generation with derivatives. As such, in an embodiment, advantages with the approaches to library generation with derivatives described herein include, but are not limited to, a significant overall library generation time reduction, and library quality improvement. It is to be understood that, although described in detail above and below, one or more methods or approaches described herein need be limited to a neural network approach of constructing a library.

In an embodiment, then, neural networks are trained using both function information and derivative information. In one such embodiment, three sets of data are thus provided for a given profile: (1) profiles (e.g., CDs with different values, system parameters such as wavelength or angle of incidence, or calibration parameters, dielectric parameters, material constants or process parameters) {xᵢ}, (2) corresponding spectra {yᵢ}, which can include wavelength-resolved, angle-resolved, polarization-resolved and other optical signals, and (3) derivatives of spectra with respect to parameters

$$\{ \frac{\partial {y}_{i}}{\partial {x}_{j}} \} .$$

The training algorithm may thus be extended to optimize the objective functions of equation (4):

$${Min}_{{W}^{1} , {W}^{2} , {W}^{3} , {b}^{3} , {b}^{2} , {b}^{1}} ( u {\sum }_{i = 1}^{N} {( {f}_{i} - {y}_{i} )}^{2} + {\sum }_{i = 1}^{N} {\sum }_{j = 1}^{NDOF} {{v}_{j} ( \frac{\partial {f}_{i}}{\partial {x}_{j}} - \frac{\partial {y}_{i}}{\partial {x}_{j}} )}^{2} ) . \qquad ( 4 )$$

It is to be understood that the derivative values are drastically different to the function values. The scaling factors u and vⱼ are included in the above objective function to balance those different contributions. During the training, two different derivatives are evaluated with the given neural network: derivatives of y (spectra) with respect to x (input CD parameters):

$$\frac{\partial {f}_{i}}{\partial {x}_{j}}$$

and derivatives of the those derivatives with respect to weights:

$$\frac{\partial }{\partial {w}_{k}} ( \frac{\partial {f}_{i}}{\partial {x}_{j}} ) .$$

Practical examples follow to illustrate implementations of the above described approaches, in accordance with one or more embodiments of the present invention. For example, in one embodiment, a synthetic data set is used in testing library generation with derivatives. The data were generated with a scaled sinusoidal function using three unknowns. Derivatives were also determined. FIG. 2 is a Table 200 illustrating three test cases for implementing derivatives information, in accordance with an embodiment of the present invention. Referring to Table 200, test cases 1 and 2 have the same amount of normalized information for training. Case 1 utilizes function values only, while case 2 utilizes both function and derivatives. 200 independent set of data were used for validation after the libraries were generated. Test case 3 utilized a much larger number of samples. FIG. 3 is a Table 300 summarizing the standard deviation of errors for the three test cases of Table 200, in accordance with an embodiment of the present invention. Referring to Table 300, case 2 provides a better quality library with smaller generation errors compared with test case 1.

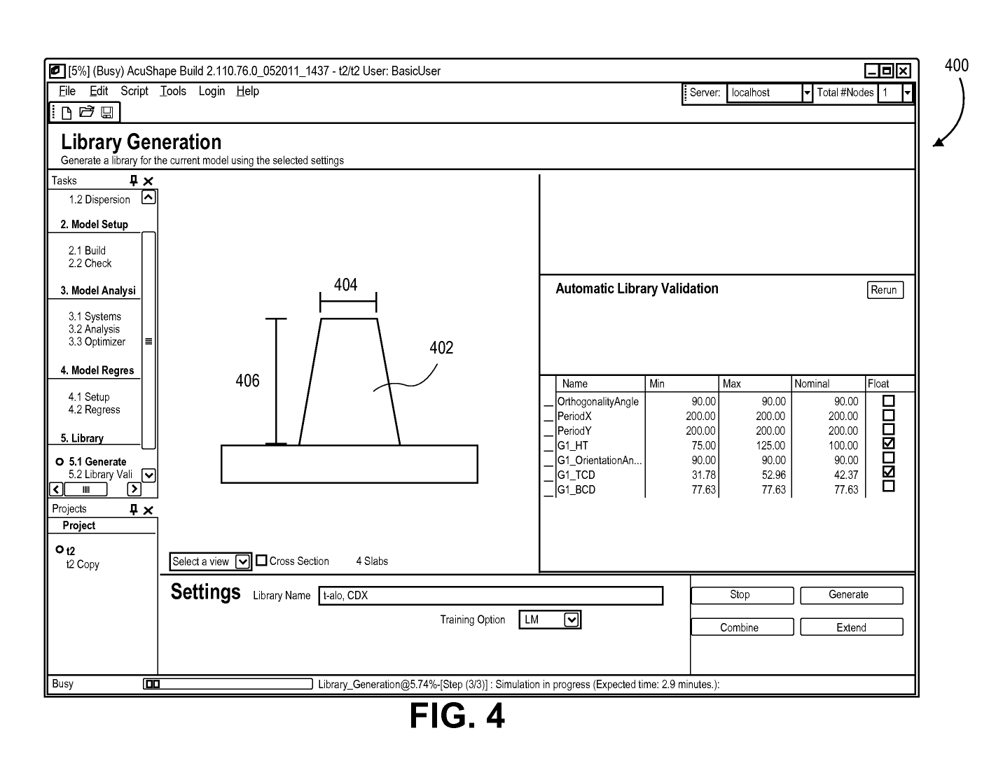

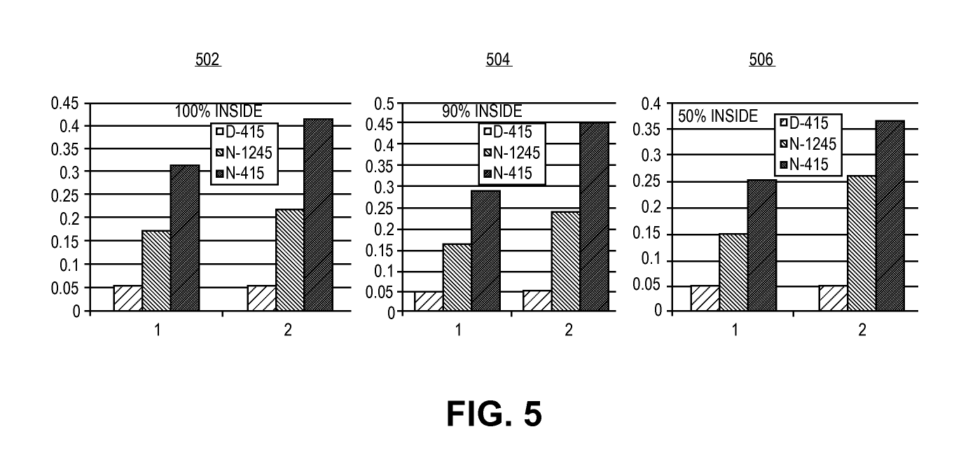

As another format of illustrating one or more concepts described herein, FIG. 4 illustrates a screen shot 400 of a testing workbook, in accordance with an embodiment of the present invention. Referring to the screen shot 400 a workbook with a trapezoidal shape 402 is generated for the testing purposes. A top critical dimension (CD) 404 and height 406 of the trapezoidal shape 402 are floating parameters. Three libraries were generated for the testing workbook of FIG. 4. Library 1 used 1245 profiles and the corresponding spectra without any derivatives. Library 2 used 415 profiles, the corresponding spectra and derivatives. Library 3 used 415 profiles and the corresponding spectra without derivatives. FIG. 5 includes plots 502, 504 and 506 of the Error3Sigma divided by precision for 50 testing profiles in three different regions based on the workbook of FIG. 4, in accordance with an embodiment of the present invention. Referring to FIG. 5, plot 502 includes 100% of the library boundary, plot 504 includes 90% inside the library boundary, and plot 506 includes 50% inside the library boundary. An evaluation of plots 502, 504 and 506 indicates that the libraries generated with derivatives have better library quality given the same normalized amount input data for training.

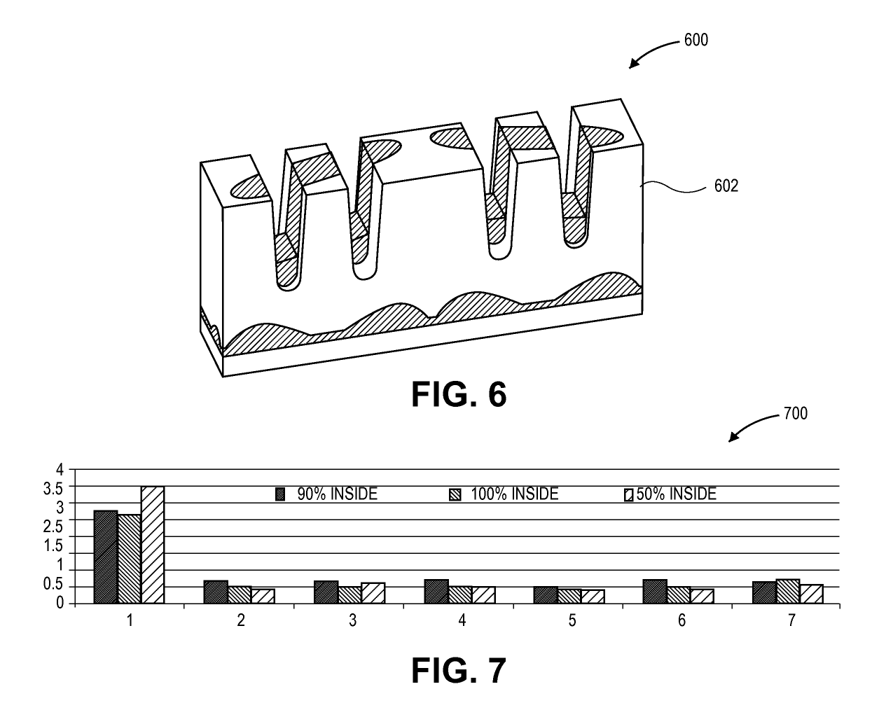

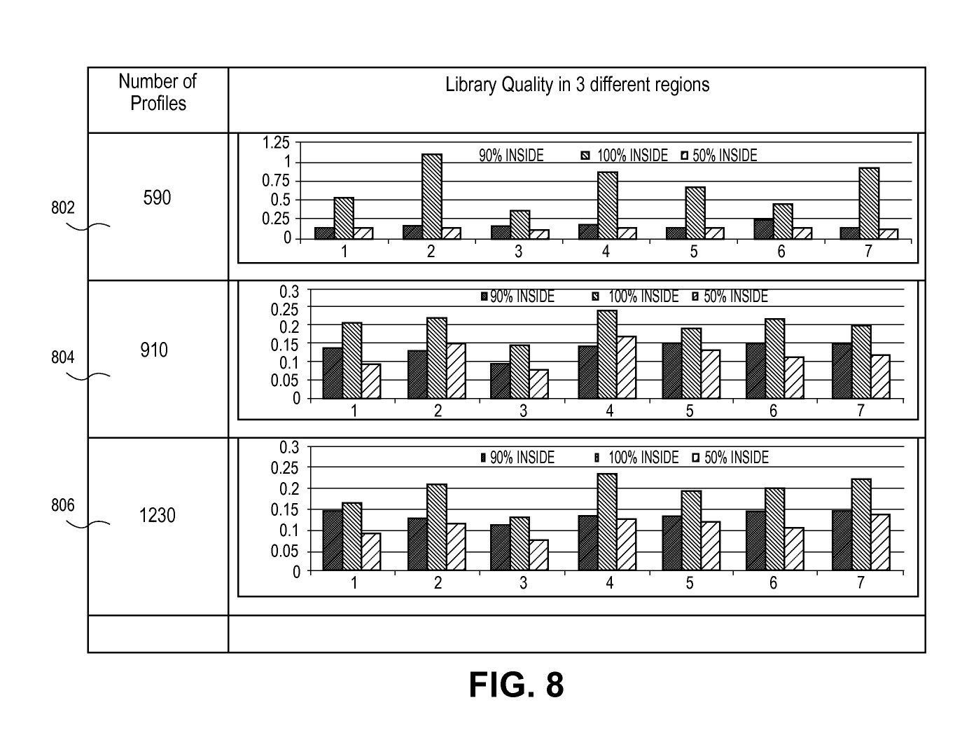

A more sophisticated workbook may also benefit from using derivative information. As an example, FIG. 6 illustrates a profile geometry 602 of a more complicated workbook 600, in accordance with an embodiment of the present invention. The workbook 600 has seven parameters, 46 slabs, and 70 wavelengths for a UVSE subsystem. Without derivatives, 7000 profiles were used to generate a library. FIG. 7 includes a plot 700 of the Error3Sigma divided by precision in three different regions based on the workbook of FIG. 6 without using derivative information. By contrast, FIG. 8 includes plots 802, 804 and 806 of the Error3Sigma divided by precision in three different regions based on the workbook of FIG. 6 using derivative information, each plot utilizing a different number of profiles, in accordance with an embodiment of the present invention. Referring to plots 700 versus plots 802, 804 and 806, with 910 profiles, the library quality is better than that generated with 7000 profiles without derivative information. For the first parameter, the library quality is approximately 10 times better. The overall library generation time is about two times faster.

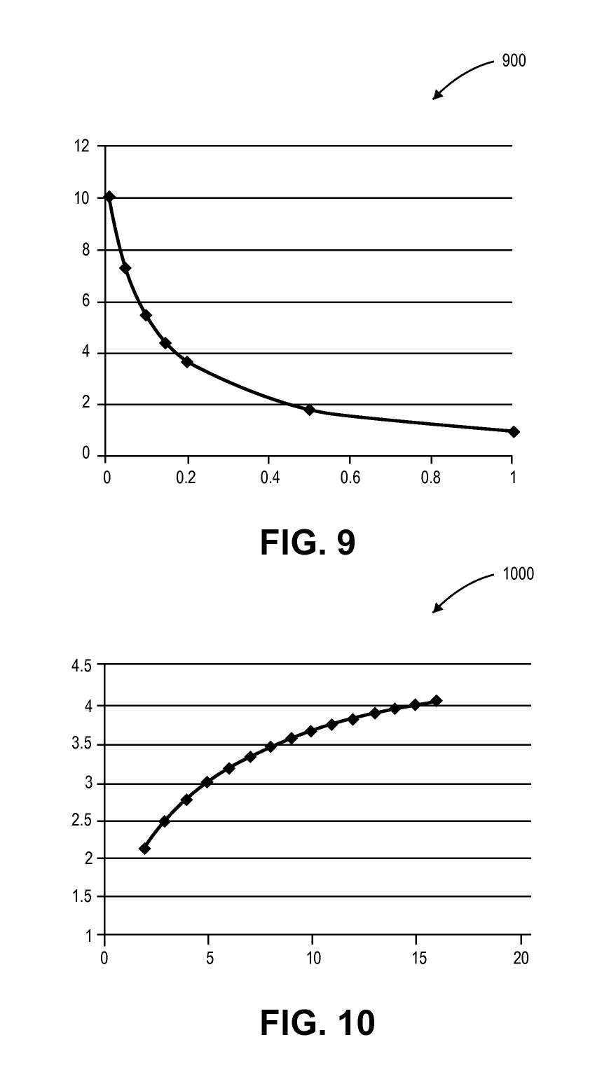

As described above, in an embodiment, training time is improved or “sped-up” using derivative information. For example, in one embodiment, assuming that training time is similar with the same amount of the normalized information, the best possible speedup by using the approaches described herein is (1+NDOF)/(1+A/100*NDOF), where A is percentage of the computational cost of a derivative versus that of a full forward solve. As a specific example, FIG. 9 includes a plot 900 revealing a speedup factor for computations for a workbook using 10 degrees of freedom (DOFs) along with derivative information, in accordance with an embodiment of the present invention. FIG. 10 includes a plot 1000 demonstrating a speedup prediction for varying DOFs based on a fixed computational cost of a derivative of 20%, in accordance with an embodiment of the present invention.

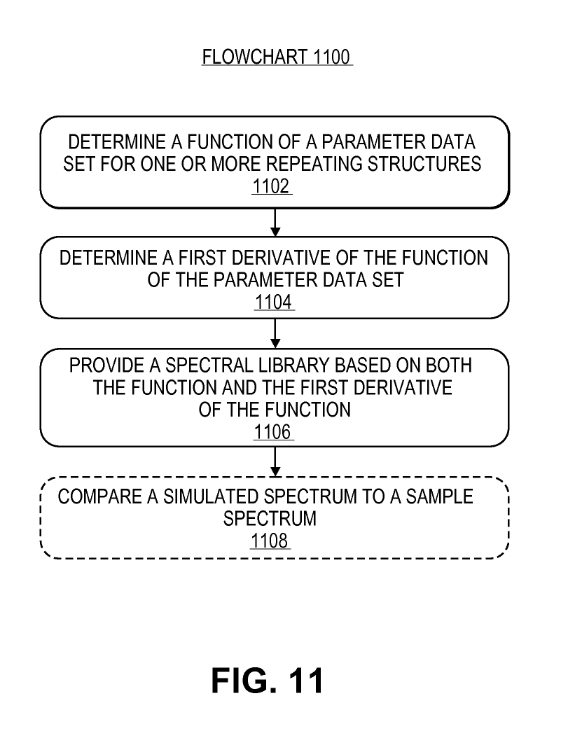

FIG. 11 depicts a flowchart 1100 representing operations in a method of library generation with derivatives for optical metrology, in accordance with an embodiment of the present invention. Referring to operation 1102 of flowchart 1100, a method of generating a library for optical metrology determining a function of a parameter data set for one or more repeating structures on a semiconductor substrate or wafer. In one embodiment, determining the function of the parameter data set includes determining a function of a shape profile of the one or more repeating structures (and may use, e.g., an analytical derivative below in operation 1104). In one embodiment, determining the function of the parameter data set includes determining a function of a material composition of the one or more repeating structures (and may use, e.g., a numerical derivative below in operation 1104).

Referring to operation 1104 of flowchart 1100, the method further includes determining a first derivative of the function of the parameter data set. In one embodiment, determining the first derivative includes determining an analytical derivative of the function of the parameter data set. In one embodiment, determining the first derivative includes determining a numerical derivative of the function of the parameter data set. In one embodiment, the method further includes determining a higher order derivative of the function of the parameter data set. In one embodiment, determining the first derivative includes determining both an analytical derivative and a numerical derivative of the function of the parameter data set.

Referring to operation 1106 of flowchart 1100, the method further includes providing a spectral library based on both the function and the first derivative of the function. In one embodiment, providing the spectral library is further based on the higher order derivative of the function. In one embodiment, providing the spectral library includes training a neural network using both the function and the first derivative of the function.

Referring to operation 1108, in an embodiment, the spectral library includes a simulated spectrum, and the method optionally further includes comparing the simulated spectrum to a sample spectrum.

In general, orders of a diffraction signal may be simulated as being derived from a periodic structure. The zeroth order represents a diffracted signal at an angle equal to the angle of incidence of a hypothetical incident beam, with respect to the normal N of the periodic structure. Higher diffraction orders are designated as +1, +2, +3, −1, −2, −3, etc. Other orders known as evanescent orders may also be considered. In accordance with an embodiment of the present invention, a simulated diffraction signal is generated for use in optical metrology. For example, profile parameters, such as structural shape and film thicknesses, may be modeled for use in optical metrology. Optical properties of materials, such as index of refraction and coefficient of extinction, (n & k), in structures may also be modeled for use in optical metrology.

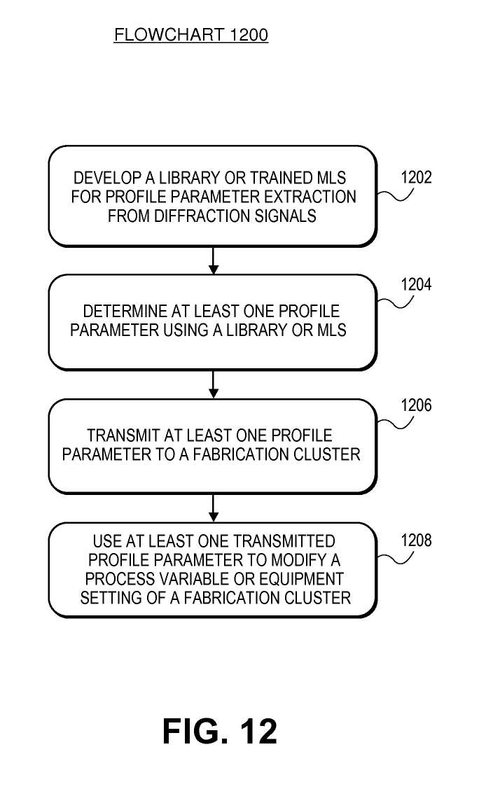

Calculations based simulated diffraction orders may be indicative of profile parameters for a patterned film, such as a patterned semiconductor film or structure based on a stack of films, and may be used for calibrating automated processes or equipment control. FIG. 12 depicts a flowchart 1200 representing an exemplary series of operations for determining and utilizing structural parameters for automated process and equipment control, in accordance with an embodiment of the present invention.

Referring to operation 1202 of flowchart 1200, a library or trained machine learning systems (MLS) is developed to extract parameters from a set of measured diffraction signals. In operation 1204, at least one parameter of a structure is determined using the library or the trained MLS. In operation 1206, the at least one parameter is transmitted to a fabrication cluster configured to perform a processing operation, where the processing operation may be executed in the semiconductor manufacturing process flow either before or after measurement operation 1204 is made. In operation 1208, the at least one transmitted parameter is used to modify a process variable or equipment setting for the processing operation performed by the fabrication cluster.

For a more detailed description of machine learning systems and algorithms, see U.S. Pat. No. 7,831,528, entitled OPTICAL METROLOGY OF STRUCTURES FORMED ON SEMICONDUCTOR WAFERS USING MACHINE LEARNING SYSTEMS, filed on Jun. 27, 2003, which is incorporated herein by reference in its entirety. For a description of diffraction order optimization for two dimensional repeating structures, see U.S. Pat. No. 7,428,060, entitled OPTIMIZATION OF DIFFRACTION ORDER SELECTION FOR TWO-DIMENSIONAL STRUCTURES, filed on Mar. 24, 2006, which is incorporated herein by reference in its entirety.

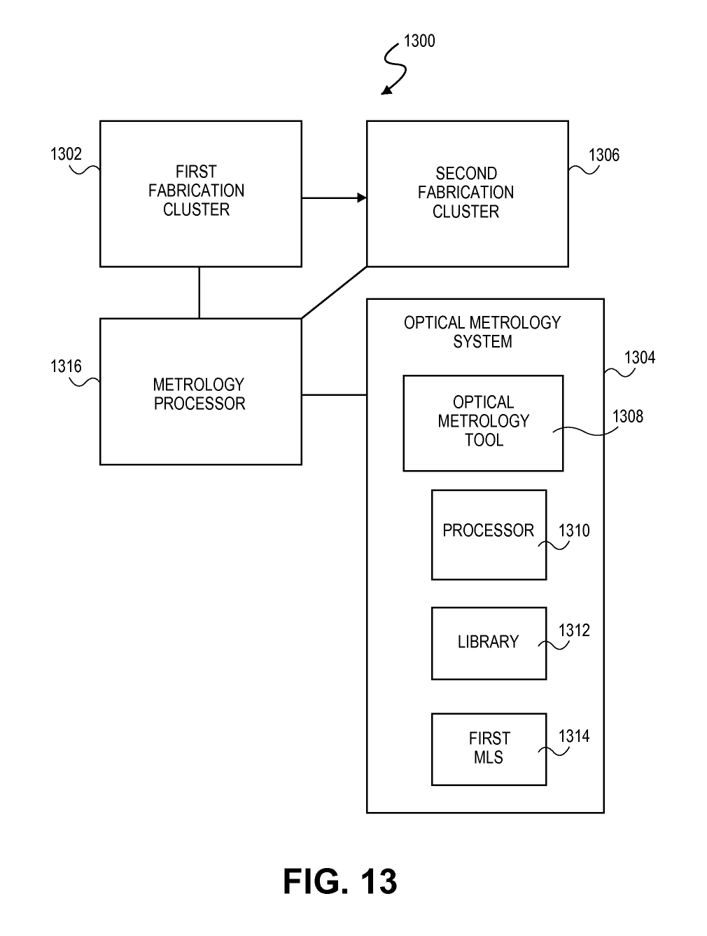

FIG. 13 is an exemplary block diagram of a system 1300 for determining and utilizing structural parameters, such as profile or film thickness parameters, for automated process and equipment control, in accordance with an embodiment of the present invention. System 1300 includes a first fabrication cluster 1302 and optical metrology system 1304. System 1300 also includes a second fabrication cluster 1306. Although the second fabrication cluster 1306 is depicted in FIG. 13 as being subsequent to first fabrication cluster 1302, it should be recognized that second fabrication cluster 1306 can be located prior to first fabrication cluster 1302 in system 1300 (and, e.g., in the manufacturing process flow).

In one exemplary embodiment, optical metrology system 1304 includes an optical metrology tool 1308 and processor 1310. Optical metrology tool 1308 is configured to measure a diffraction signal obtained from the structure. If the measured diffraction signal and the simulated diffraction signal match, one or more values of the profile or film thickness parameters are determined to be the one or more values of the profile or film thickness parameters associated with the simulated diffraction signal.

In one exemplary embodiment, optical metrology system 1304 can also include a library 1312 with a plurality of simulated diffraction signals and a plurality of values of, e.g., one or more profile or film thickness parameters associated with the plurality of simulated diffraction signals. As described above, the library can be generated in advance. Metrology processor 1310 can be used to compare a measured diffraction signal obtained from a structure to the plurality of simulated diffraction signals in the library. When a matching simulated diffraction signal is found, the one or more values of the profile or film thickness parameters associated with the matching simulated diffraction signal in the library is assumed to be the one or more values of the profile or film thickness parameters used in the wafer application to fabricate the structure.

System 1300 also includes a metrology processor 1316. In one exemplary embodiment, processor 1310 can transmit the one or more values of the, e.g., one or more profile or film thickness parameters to metrology processor 1316. Metrology processor 1316 can then adjust one or more process parameters or equipment settings of first fabrication cluster 1302 based on the one or more values of the one or more profile or film thickness parameters determined using optical metrology system 1304. Metrology processor 1316 can also adjust one or more process parameters or equipment settings of the second fabrication cluster 1306 based on the one or more values of the one or more profile or film thickness parameters determined using optical metrology system 1304. As noted above, fabrication cluster 1306 can process the wafer before or after fabrication cluster 1302. In another exemplary embodiment, processor 1310 is configured to train machine learning system 1314 using the set of measured diffraction signals as inputs to machine learning system 1314 and profile or film thickness parameters as the expected outputs of machine learning system 1314.

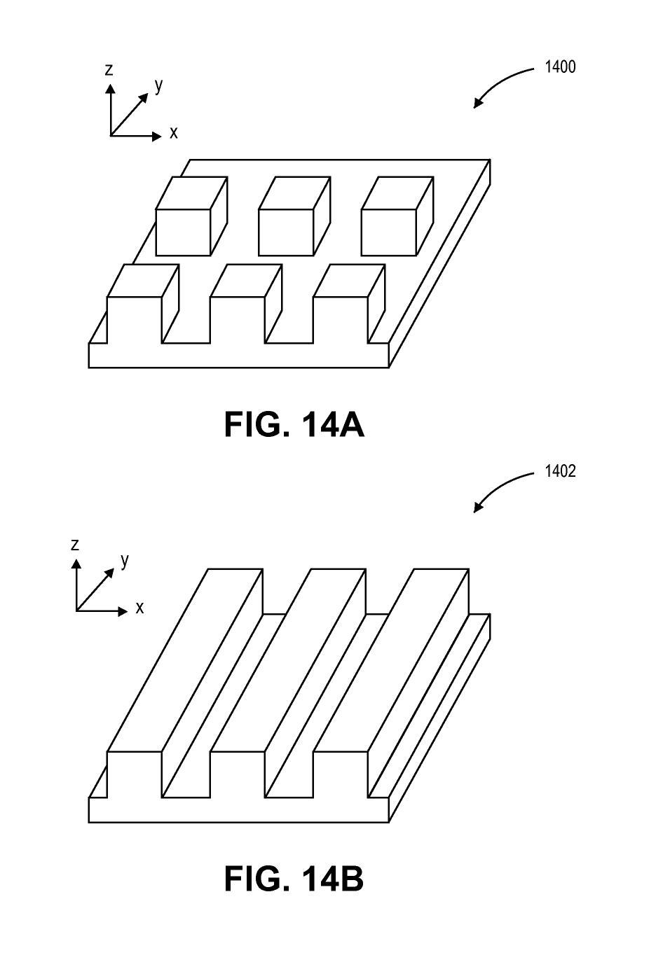

In an embodiment, optimizing a model of a structure includes using a three-dimensional grating structure. The term “three-dimensional grating structure” is used herein to refer to a structure having an x-y profile that varies in two horizontal dimensions in addition to a depth in the z-direction. For example, FIG. 14A depicts a periodic grating 1400 having a profile that varies in the x-y plane, in accordance with an embodiment of the present invention. The profile of the periodic grating varies in the z-direction as a function of the x-y profile.

In an embodiment, optimizing a model of a structure includes using a two-dimensional grating structure. The term “two-dimensional grating structure” is used herein to refer to a structure having an x-y profile that varies in only one horizontal dimension in addition to a depth in the z-direction. For example, FIG. 14B depicts a periodic grating 1402 having a profile that varies in the x-direction but not in the y-direction, in accordance with an embodiment of the present invention. The profile of the periodic grating varies in the z-direction as a function of the x profile. It is to be understood that the lack of variation in the y-direction for a two-dimensional structure need not be infinite, but any breaks in the pattern are considered long range, e.g., any breaks in the pattern in the y-direction are spaced substantially further apart than the breaks in the pattern in the x-direction.

Embodiments of the present invention may be suitable for a variety of film stacks. For example, in an embodiment, a method for optimizing a parameter of a critical dimension (CD) profile or structure is performed for a film stack including an insulating film, a semiconductor film and a metal film formed on a substrate. In an embodiment, the film stack includes a single layer or multiple layers. Also, in an embodiment invention, an analyzed or measured grating structure includes both a three-dimensional component and a two-dimensional component. For example, the efficiency of a computation based on simulated diffraction data may be optimized by taking advantage of the simpler contribution by the two-dimensional component to the overall structure and the diffraction data thereof.

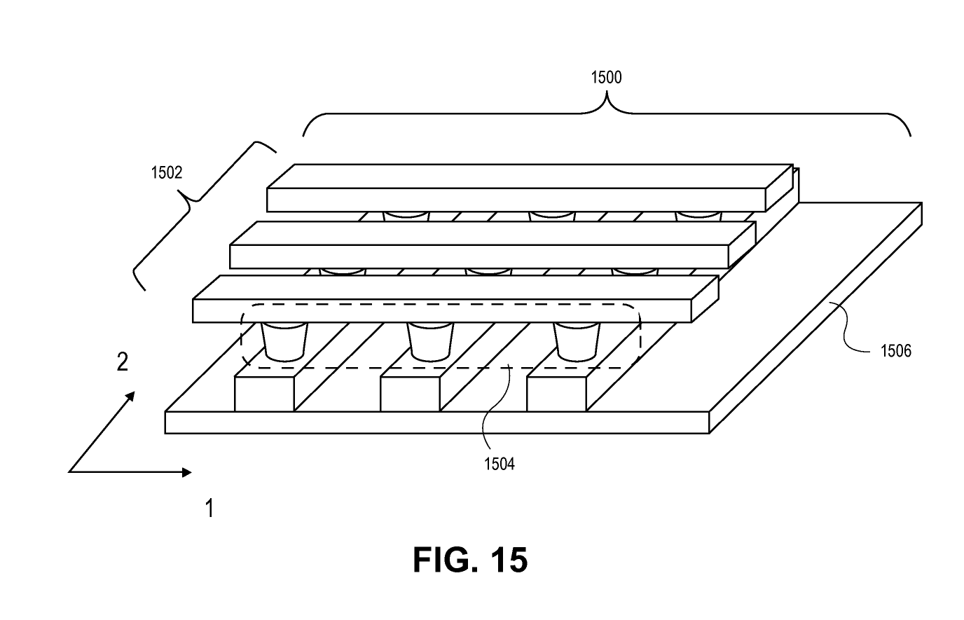

FIG. 15 represents a cross-sectional view of a structure having both a two-dimensional component and a three-dimensional component, in accordance with an embodiment of the present invention. Referring to FIG. 15, a structure 1500 has a two-dimensional component 1502 and a three-dimensional component 1504 above a substrate 1506. The grating of the two-dimensional component runs along direction 2, while the grating of the three-dimensional component runs along both directions 1 and 2. In one embodiment, direction 1 is orthogonal to direction 2, as depicted in FIG. 15. In another embodiment, direction 1 is non-orthogonal to direction 2.

The above methods may be implemented in an optical critical dimension (OCD) product such as “Acushape” as a utility for an applications engineer to use after initial or preliminary models have been tested. Also, commercially available software such as “COMSOL Multiphysics” may be used to identify regions of an OCD model for alteration. The simulation results from such a software application may be used to predict a region for successful model improvement.

In an embodiment, the method of optimizing a model of a structure further includes altering parameters of a process tool based on an optimized parameter. A concerted altering of the process tool may be performed by using a technique such as, but not limited to, a feedback technique, a feed-forward technique, and an in situ control technique.

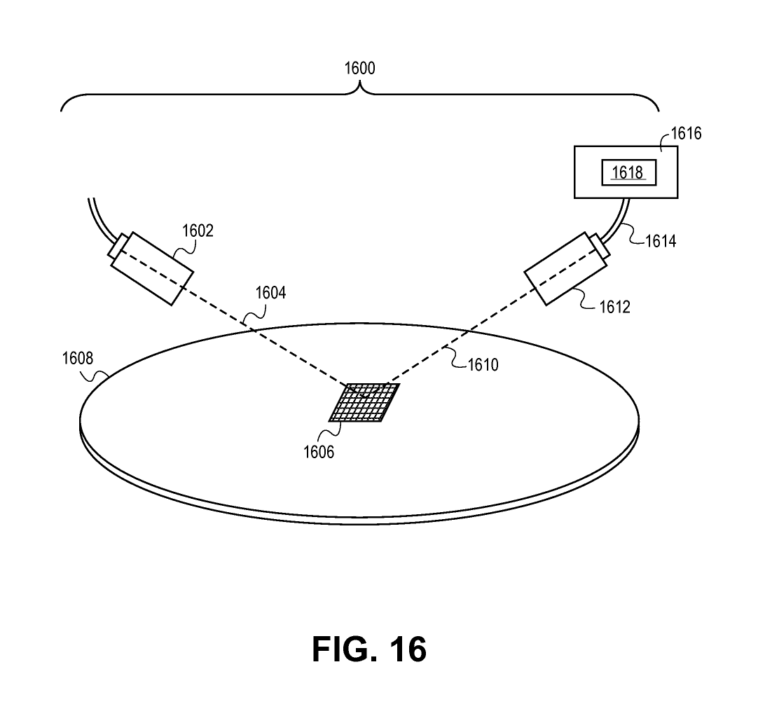

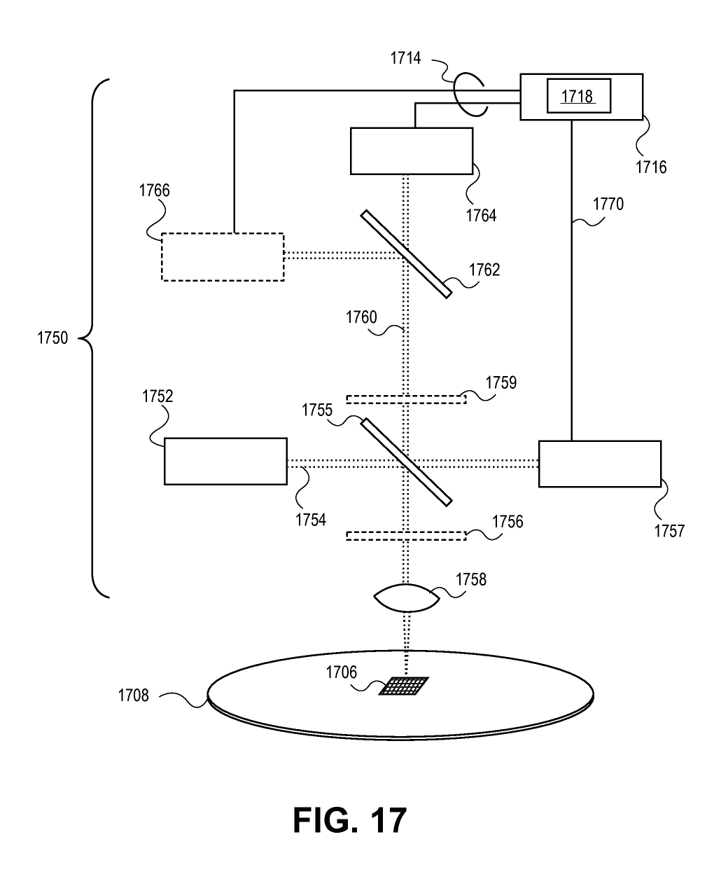

In accordance with an embodiment of the present invention, a method of optimizing a model of a structure further includes comparing a simulated spectrum to a sample spectrum. In one embodiment, a set of diffraction orders is simulated to represent diffraction signals from a two- or three-dimensional grating structure generated by an ellipsometric optical metrology system, such as the optical metrology systems 1600 or 1750 described below in association with FIGS. 16 and 17, respectively. However, it is to be understood that the same concepts and principles equally apply to the other optical metrology systems, such as reflectometric systems. The diffraction signals represented may account for features of the two- and three-dimensional grating structure such as, but not limited to, profile, dimension, material composition, or film thickness.

FIG. 16 is an architectural diagram illustrating the utilization of optical metrology to determine parameters of structures on a semiconductor wafer, in accordance with embodiments of the present invention. The optical metrology system 1600 includes a metrology beam source 1602 projecting a metrology beam 1604 at the target structure 1606 of a wafer 1608. The metrology beam 1604 is projected at an incidence angle 8 towards the target structure 1606 (8 is the angle between the incident beam 1604 and a normal to the target structure 1606). The ellipsometer may, in one embodiment, use an incidence angle of approximately 60° to 70°, or may use a lower angle (possibly close to 0° or near-normal incidence) or an angle greater than 70° (grazing incidence). The diffraction beam 1610 is measured by a metrology beam receiver 1612. The diffraction beam data 1614 is transmitted to a profile application server 1616. The profile application server 1616 may compare the measured diffraction beam data 1614 against a library 1618 of simulated diffraction beam data representing varying combinations of critical dimensions of the target structure and resolution.

In one exemplary embodiment, the library 1618 instance best matching the measured diffraction beam data 1614 is selected. It is to be understood that although a library of diffraction spectra or signals and associated hypothetical profiles or other parameters is frequently used to illustrate concepts and principles, embodiments of the present invention may apply equally to a data space including simulated diffraction signals and associated sets of profile parameters, such as in regression, neural network, and similar methods used for profile extraction. The hypothetical profile and associated critical dimensions of the selected library 1616 instance is assumed to correspond to the actual cross-sectional profile and critical dimensions of the features of the target structure 1606. The optical metrology system 1600 may utilize a reflectometer, an ellipsometer, or other optical metrology device to measure the diffraction beam or signal.

In order to facilitate the description of embodiments of the present invention, an ellipsometric optical metrology system is used to illustrate the above concepts and principles. It is to be understood that the same concepts and principles apply equally to the other optical metrology systems, such as reflectometric systems. In an embodiment, the optical scatterometry is a technique such as, but not limited to, optical spectroscopic ellipsometry (SE), beam-profile reflectometry (BPR), beam-profile ellipsometry (BPE), and ultra-violet reflectometry (UVR). In a similar manner, a semiconductor wafer may be utilized to illustrate an application of the concept. Again, the methods and processes apply equally to other work pieces that have repeating structures.

FIG. 17 is an architectural diagram illustrating the utilization of beam-profile reflectometry and/or beam-profile ellipsometry to determine parameters of structures on a semiconductor wafer, in accordance with embodiments of the present invention. The optical metrology system 1750 includes a metrology beam source 1752 generating a polarized metrology beam 1754. Preferably this metrology beam has a narrow bandwidth of 10 nanometers or less. In some embodiments, the source 1752 is capable of outputting beams of different wavelengths by switching filters or by switching between different lasers or super-bright light emitting diodes. Part of this beam is reflected from the beam splitter 1755 and focused onto the target structure 1706 of a wafer 1708 by objective lens 1758, which has a high numerical aperture (NA), preferably an NA of approximately 0.9 or 0.95. The portion of the beam 1754 that is not reflected from the beam splitter is directed to beam intensity monitor 1757. The metrology beam may, optionally, pass through a quarter-wave plate 1756 before the objective lens 1758.

After reflection from the target the reflected beam 1760 passes back through the objective lens and is directed to one or more detectors. If optional quarter-wave plate 1756 is present, the beam will pass back through that quarter-wave plate before being transmitted through the beam splitter 1755. After the beam-splitter, the reflected beam 1760 may optionally pass through a quarter-wave plate at location 1759 as an alternative to location 1756. If the quarter-wave plate is present at location 1756, it will modify both the incident and reflected beams. If it is present at location 1759, it will modify only the reflected beam. In some embodiments, no wave plate may be present at either location, or the wave plate may be switched in and out depending on the measurement to be made. It is to be understood that in some embodiments it might be desirable that the wave plate have a retardance substantially different from a quarter wave, i.e. the retardance value might be substantially greater than, or substantially less than, 90°.

A polarizer or polarizing beam splitter 1762 directs one polarization state of the reflected beam 1760 to detector 1764, and, optionally, directs a different polarization state to an optional second detector 1766. The detectors 1764 and 1766 might be one-dimensional (line) or two-dimensional (array) detectors. Each element of a detector corresponds to a different combination of AOI and azimuthal angles for the corresponding ray reflected from the target. The diffraction beam data 1714 from the detector(s) is transmitted to the profile application server 1716 along with beam intensity data 1770. The profile application server 1716 may compare the measured diffraction beam data 1714 after normalization or correction by the beam intensity data 1770 against a library 1718 of simulated diffraction beam data representing varying combinations of critical dimensions of the target structure and resolution.

For more detailed descriptions of systems that could be used to measure the diffraction beam data or signals for use with the present invention, see U.S. Pat. No. 6,734,967, entitled FOCUSED BEAM SPECTROSCOPIC ELLIPSOMETRY METHOD AND SYSTEM, filed on Feb. 11, 1999, and U.S. Pat. No. 6,278,519 entitled APPARATUS FOR ANALYZING MULTI-LAYER THIN FILM STACKS ON SEMICONDUCTORS, filed Jan. 29, 1998, both of which are incorporated herein by reference in their entirety. These two patents describe metrology systems that may be configured with multiple measurement subsystems, including one or more of a spectroscopic ellipsometer, a single-wavelength ellipsometer, a broadband reflectometer, a DUV reflectometer, a beam-profile reflectometer, and a beam-profile ellipsometer. These measurement subsystems may be used individually, or in combination, to measure the reflected or diffracted beam from films and patterned structures. The signals collected in these measurements may be analyzed to determine parameters of structures on a semiconductor wafer in accordance with embodiments of the present invention.

Embodiments of the present invention may be provided as a computer program product, or software, that may include a machine-readable medium having stored thereon instructions, which may be used to program a computer system (or other electronic devices) to perform a process according to the present invention. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., infrared signals, digital signals, etc.)), etc.

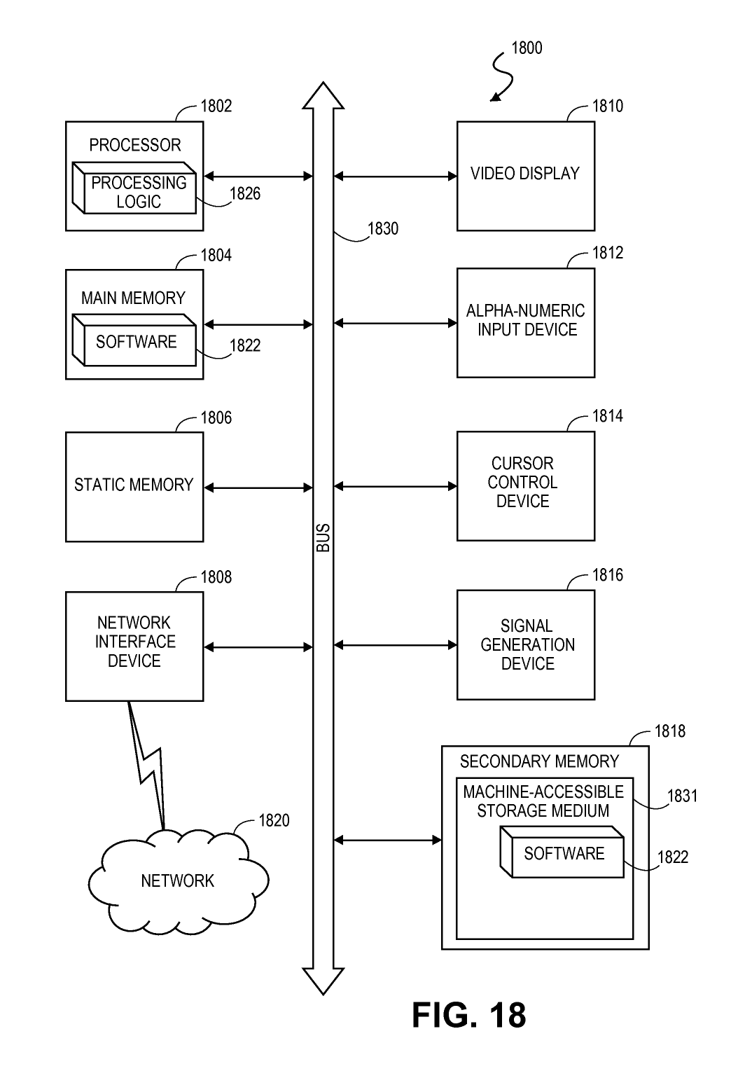

FIG. 18 illustrates a diagrammatic representation of a machine in the exemplary form of a computer system 1800 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1800 includes a processor 1802, a main memory 1804 (e.g., read-only memory (ROM), flash memory, dynamic random access memory (DRAM) such as synchronous DRAM (SDRAM) or Rambus DRAM (RDRAM), etc.), a static memory 1806 (e.g., flash memory, static random access memory (SRAM), etc.), and a secondary memory 1818 (e.g., a data storage device), which communicate with each other via a bus 1830.

Processor 1802 represents one or more general-purpose processing devices such as a microprocessor, central processing unit, or the like. More particularly, the processor 1802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1802 may also be one or more special-purpose processing devices such as an application specific integrated circuit (ASIC), a field programmable gate array (FPGA), a digital signal processor (DSP), network processor, or the like. Processor 1802 is configured to execute the processing logic 1826 for performing the operations discussed herein.

The computer system 1800 may further include a network interface device 1808. The computer system 1800 also may include a video display unit 1810 (e.g., a liquid crystal display (LCD) or a cathode ray tube (CRT)), an alphanumeric input device 1812 (e.g., a keyboard), a cursor control device 1814 (e.g., a mouse), and a signal generation device 1816 (e.g., a speaker).

The secondary memory 1818 may include a machine-accessible storage medium (or more specifically a computer-readable storage medium) 1831 on which is stored one or more sets of instructions (e.g., software 1822) embodying any one or more of the methodologies or functions described herein. The software 1822 may also reside, completely or at least partially, within the main memory 1804 and/or within the processor 1802 during execution thereof by the computer system 1800, the main memory 1804 and the processor 1802 also constituting machine-readable storage media. The software 1822 may further be transmitted or received over a network 1820 via the network interface device 1808.

While the machine-accessible storage medium 1831 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present invention. The term “machine-readable storage medium” shall accordingly be taken to include, but not be limited to, solid-state memories, and optical and magnetic media.

In accordance with an embodiment of the present invention, a non-transitory machine-accessible storage medium has instructions stored thereon which cause a data processing system to perform a method of generating a library for optical metrology. The method includes determining a function of a parameter data set for one or more repeating structures on a semiconductor substrate or wafer. The method also includes determining a first derivative of the function of the parameter data set. The method also includes providing the spectral library based on both the function and the first derivative of the function.

In an embodiment, determining the first derivative includes determining an analytical derivative of the function of the parameter data set.

In an embodiment, determining the first derivative includes determining a numerical derivative of the function of the parameter data set.

In an embodiment, the method further includes determining a higher order derivative of the function of the parameter data set. Providing the spectral library is further based on the higher order derivative of the function.

In an embodiment, determining the first derivative includes determining both an analytical derivative and a numerical derivative of the function of the parameter data set.

In an embodiment, determining the function of the parameter data set includes determining a function of a shape profile of the one or more repeating structures.

In an embodiment, determining the function of the parameter data set includes determining a function of a material composition of the one or more repeating structures.

In an embodiment, providing the spectral library includes training a neural network using both the function and the first derivative of the function.

In an embodiment, the spectral library includes a simulated spectrum. The method further includes comparing the simulated spectrum to a sample spectrum.

It is to be understood that the above methodologies may be applied under a variety of circumstances within the spirit and scope of embodiments of the present invention. For example, in an embodiment, measurements described above are performed with or without the presence of background light. In an embodiment, a method described above is performed in a semiconductor, solar, light-emitting diode (LED), or a related fabrication process. In an embodiment, a method described above is used in a stand-alone or an integrated metrology tool.

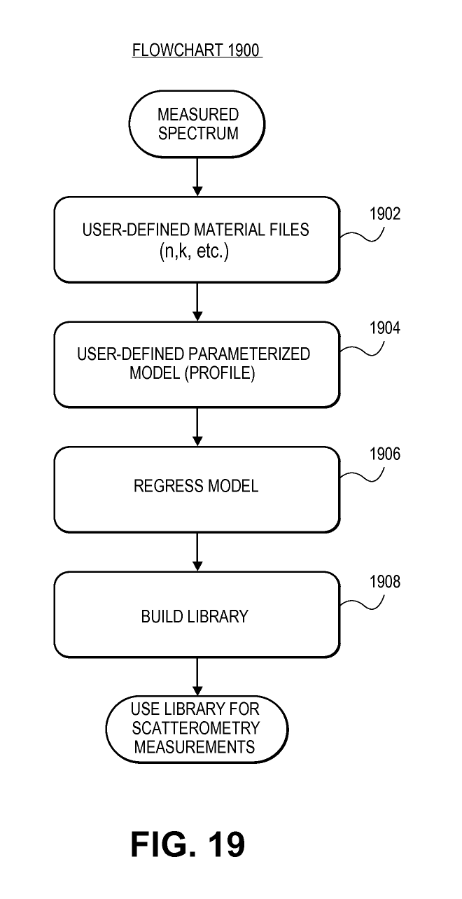

Analysis of measured spectra generally involves comparing the measured sample spectra to simulated spectra to deduce parameter values of a model that best describe the measured sample. FIG. 19 is a flowchart 1900 representing operations in a method for a building parameterized model and a spectral library beginning with sample spectra (e.g., originating from one or more workpieces), in accordance with an embodiment of the present invention.

At operation 1902, a set of material files are defined by a user to specify characteristics (e.g., refractive index or n, k values) of the material(s) from which the measured sample feature is formed.

At operation 1904, a scatterometry user defines a nominal model of the expected sample structure by selecting one or more of the material files to assemble a stack of materials corresponding to those present in the periodic grating features to be measured. Such a user-defined model may be further parameterized through definition of nominal values of model parameters, such as thicknesses, critical dimension (CD), sidewall angle (SWA), height (HT), edge roughness, corner rounding radius, etc. which characterize the shape of the feature being measured. Depending on whether a two-dimensional model (i.e., a profile) or three-dimensional model is defined, it is not uncommon to have 30-50, or more, such model parameters.

From a parameterized model, simulated spectra for a given set of grating parameter values may be computed using rigorous diffraction modeling algorithms, such as Rigorous Coupled Wave Analysis (RCWA). Regression analysis is then performed at operation 1906 until the parameterized model converges on a set of parameter values characterizing a final profile model (for two-dimensional) that corresponds to a simulated spectrum which matches the measured diffraction spectra to a predefined matching criterion. The final profile model associated with the matching simulated diffraction signal is presumed to represent the actual profile of the structure from which the model was generated.

The matching simulated spectra and/or associated optimized profile model can then be utilized at operation 1908 to build a library of simulated diffraction spectra by perturbing the values of the parameterized final profile model. The resulting library of simulated diffraction spectra may then be employed by a scatterometry measurement system operating in a production environment to determine whether subsequently measured grating structures have been fabricated according to specifications. Library generation 1908 may include a machine learning system, such as a neural network, generating simulated spectral information for each of a number of profiles, each profile including a set of one or more modeled profile parameters. In order to generate the library, the machine learning system itself may have to undergo some training based on a training data set of spectral information. Such training may be computationally intensive and/or may have to be repeated for different models and/or profile parameter domains. Considerable inefficiency in the computational load of generating a library may be introduced by a user's decisions regarding the size of a training data set. For example, selection of an overly large training data set may result in unnecessary computations for training while training with a training data set of insufficient size may necessitate a retraining to generate a library.

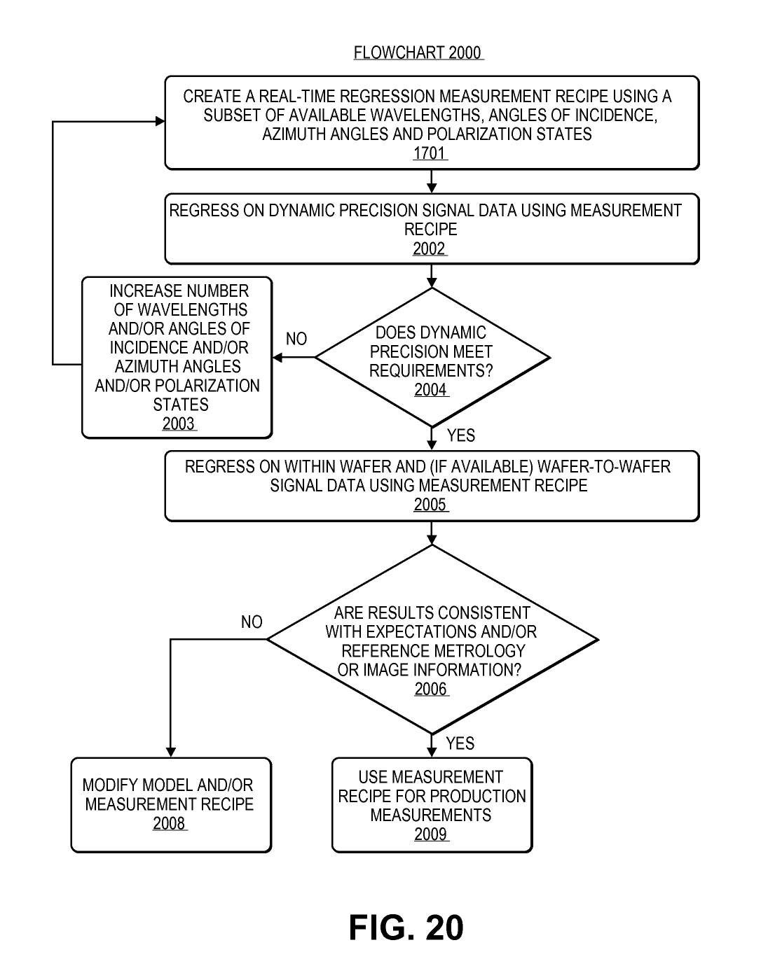

FIG. 20 depicts a flowchart 2000 representing operations in a method of constructing and optimizing a library using an optical parametric model, in accordance with an embodiment of the present invention. Not every operation shown is always required. Some libraries may be optimized using a subset of the operations shown. It should be understood that some of these operations may be performed in a different sequence or that additional operations may be inserted into the sequence without departing from the scope of the present invention.

Referring to operation 2001, a library is created using a parametric model. That parametric model may have been created and optimized using a process such as the process described in association with flowchart 1100. The library is preferably created for a subset of the available wavelengths and angles in order to keep the library size small and to speed the library match or search. The library is then used to match dynamic precision signal data as shown at operation 2002 and hence determine the precision or repeatability of the measurement using that library. If the resulting precision does not meet requirements (operation 2004), then the number of wavelengths and/or angles and/or polarization states used needs to be increased as shown at operation 2003 and the process repeated. It is to be understood that if the dynamic precision is significantly better than required, it may be desirable to reduce the number of wavelengths and/or angles and/or polarization states in order to make a smaller, faster library. Embodiments of the present invention can be used to determine which additional wavelengths, angles or incidence, azimuth angles and/or polarizations states to include in the library.

When the library has been optimized for precision, any additional data that is available can be matched using that library as shown at operation 2005. The results from the larger set of data can be compared with reference data such as cross-section electron micrographs and also checked for consistency between wafers (for example, two wafers processed on the same equipment will usually show similar across-wafer variations) as shown at operation 2006. If the results meet expectations, then the library is ready for scatterometry measurements of production wafers (operation 2009). If the results do not meet expectations, then the library and/or parametric model need to be updated and the resulting new library retested (operation 2008). One or more embodiments of the present invention can used to determine what changes have to be made to the library or parametric model to improve the results.

As illustrated in the above examples, the process of developing parametric models and libraries and real-time regression recipes that use those parametric models is often an iterative process. The present invention can significantly reduce the number of iterations required to arrive at parametric model and the libraries or real-time regression recipe using that model as compare with a trial-end-error approach. The present invention also significantly improves the measurement performance of the resulting parametric models, libraries and real-time regression recipes since the model parameters, wavelengths, angles of incidence, azimuthal angles and polarization states can all be chosen based on optimizing sensitivity and reducing correlations.

It is also to be understood that embodiments of the present invention also include the use of the techniques related to machine learning systems such as neural networks and support vector machines to generate simulated diffraction signals.

Thus, methods of library generation with derivatives for optical metrology have been disclosed. In accordance with an embodiment of the present invention, a method includes determining a function of a parameter data set for one or more repeating structures on a semiconductor substrate or wafer. The method also includes determining a first derivative of the function of the parameter data set. The method also includes providing a spectral library based on both the function and the first derivative of the function.

What is claimed is:

1. A method of generating a library for optical metrology, the method comprising:
determining a function of a parameter data set for one or more repeating structures on a semiconductor substrate or wafer;
determining a first derivative of the function of the parameter data set; and
providing a spectral library based on both the function and the first derivative of the function.

2. The method of claim 1, wherein determining the first derivative comprises determining an analytical derivative of the function of the parameter data set.

3. The method of claim 1, wherein determining the first derivative comprises determining a numerical derivative of the function of the parameter data set.

4. The method of claim 1, the method further comprising:
determining a higher order derivative of the function of the parameter data set, wherein providing the spectral library is further based on the higher order derivative of the function.

5. The method of claim 1, wherein determining the first derivative comprises determining both an analytical derivative and a numerical derivative of the function of the parameter data set.

6. The method of claim 1, wherein determining the function of the parameter data set comprises determining a function of a shape profile of the one or more repeating structures.

7. The method of claim 1, wherein determining the function of the parameter data set comprises determining a function of a material composition of the one or more repeating structures.

8. The method of claim 1, wherein providing the spectral library comprises training a neural network using both the function and the first derivative of the function.

9. The method of claim 1, wherein the spectral library comprises a simulated spectrum, the method further comprising:
comparing the simulated spectrum to a sample spectrum.

10. A non-transitory machine-accessible storage medium having instructions stored thereon which cause a data processing system to perform a method of generating a library for optical metrology, the method comprising:
determining a function of a parameter data set for one or more repeating structures on a semiconductor substrate or wafer;
determining a first derivative of the function of the parameter data set; and
providing a spectral library based on both the function and the first derivative of the function.

11. The non-transitory storage medium as in claim 10, wherein determining the first derivative comprises determining an analytical derivative of the function of the parameter data set.

12. The non-transitory storage medium as in claim 10, wherein determining the first derivative comprises determining a numerical derivative of the function of the parameter data set.

13. The non-transitory storage medium as in claim 10, the method further comprising:
determining a higher order derivative of the function of the parameter data set, wherein providing the spectral library is further based on the higher order derivative of the function.

14. The non-transitory storage medium as in claim 10, wherein determining the first derivative comprises determining both an analytical derivative and a numerical derivative of the function of the parameter data set.

15. The non-transitory storage medium as in claim 10, wherein determining the function of the parameter data set comprises determining a function of a shape profile of the one or more repeating structures.

16. The non-transitory storage medium as in claim 10, wherein determining the function of the parameter data set comprises determining a function of a material composition of the one or more repeating structures.

17. The non-transitory storage medium as in claim 10, wherein providing the spectral library comprises training a neural network using both the function and the first derivative of the function.

18. The non-transitory storage medium as in claim 10, wherein the spectral library comprises a simulated spectrum, the method further comprising:
comparing the simulated spectrum to a sample spectrum.

19. A system to generate a simulated diffraction signal to determine process parameters of a wafer application to fabricate a structure on a wafer using optical metrology, the system comprising:
a fabrication cluster configured to perform a wafer application to fabricate a structure on a wafer, wherein one or more process parameters characterize behavior of structure shape or layer thickness when the structure undergoes processing operations in the wafer application performed using the fabrication cluster;
an optical metrology system configured to determine the one or more process parameters of the wafer application, the optical metrology system comprising:
a beam source and detector configured to measure a diffraction signal of the structure;
a spectral library of simulated diffraction signals, the spectral library based on both a function and a first derivative of the function of a parameter data set of a plurality of model structures; and
a processor configured to determine, from the plurality of model structures, a model of the structure.

20. The system of claim 19, wherein the first derivative is an analytical derivative.

21. The system of claim 19, wherein the first derivative is a numerical derivative.

22. The system of claim 19, wherein the spectral library is further based on a higher order derivative of the function of the parameter data set.

23. The system of claim 19, wherein the processor is further configured to compare a simulated spectrum of the spectral library with a sample spectrum of the structure.
